(19) United States
(12) Patent Application Publication
(10) Pub. No.: US 2008/0061944 A1
(43) Pub. Date: Mar. 13, 2008

(54) Communications device

(75) Inventor: Thomas Gunther, Langenhagen (DE)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 11/898,341

(22) Filed: Sep. 11, 2007

(30) Foreign Application Priority Data
Sep. 12, 2006 (DE) 10 2006 042 735.1

(51) Int. Cl. H04B 1/59

(52) U.S. Cl. 340/10.41

(57) ABSTRACT

The disclosure relates to a communications device for transmitting data on a product to a data processing device, the product being assigned a transponder, which can be brought into communication as required with a read device assigned to the data processing device. It is proposed to equip the transponder with a transducer for converting a physical quantity of the product into an electrical quantity.

### RELATED APPLICATIONS

This application claims priority under 35 U.S.C. §119 to German Application 102006042735.1 filed in Germany on Sep. 12, 2006, the entire contents of which are hereby incorporated by reference in their entireties.

### TECHNICAL FIELD

The disclosure relates to a communications device for transmitting data on a product to a data processing device.

### BACKGROUND INFORMATION

It is known to use RFID technology (radio frequency identification) to assign to a product static information for its identification in a manner that is readable. For this purpose, the product is equipped with a transponder which essentially comprises an antenna, an analog communications circuit, a digital circuit and a permanent memory. The product identification is stored in the memory in a manner that allows it to be overwritten.

The transponder communicates without contact with a read device brought into proximity such that a high-frequency electromagnetic field generated by the read device is modified by the transponder by load modulation as a function of the stored identification. The field changes are detected in the read device and the identification encoded therein is reconstructed.

In addition, passive transponders are supplied with power from the high-frequency electromagnetic field, whilst active transponders are equipped with a local power source.

The read device can be equipped with means for forwarding the data received from the transponder to an external data processing device, or it can itself be a data processing device.

It is also known to determine physical properties of a product using sensors suitable for converting a physical quantity of the product into an electrical quantity, and to transmit them to a data processing device.

Known sensors, particularly in automation engineering, usually involve high installation costs for cables, pipe connections and the like. This makes it at least very difficult, and sometimes even impossible, to install them later or to take measurements from difficult to access or moving measurement points.

### SUMMARY

The object of the disclosure is hence to improve the known communications device so that at least one physical property of the product is kept actively ready for transmission to a data processing device.

The disclosure is based on a communications device for transmitting data on a product to a data processing device, the product being assigned a transponder, which can be brought into communication as required with a read device assigned to the data processing device.

According to the disclosure, the transponder is equipped with a transducer for converting a physical quantity of the product into an electrical quantity. The transducer is connected to the electronic circuit of the transponder in such a way that the electrical quantity output by the transducer, as an alternative to, or in conjunction with the identification, can be retrieved in the memory of the transponder as required by the read device.

In each powered transponder, irrespective of the nature of the power supply, the transducer-specific physical quantity of the product is translated into an electrical quantity, and is kept ready for retrieval as the active physical property of the product, and on retrieval is transmitted to the read device by the transport mechanisms known per se and described in the introduction.

Advantageously, in addition to the presence of a product, at least one physical property of interest of the product is also available without visual or mechanical contact with the product. Measurements of product properties are possible in this case in the product even in a hazardous area and under restrictions for reasons of hygiene.

### BRIEF DESCRIPTION OF THE DRAWINGS

Further details and advantages of the invention are described in greater detail below with reference to exemplary embodiments, where in the drawings required for this,

FIG. 1 shows a block diagram of an exemplary transponder according to the disclosure

FIG. 2 shows a block diagram for an application of the communications device in a production facility

FIG. 3 shows a block diagram for an application of the communications device in quality assurance

### DETAILED DESCRIPTION

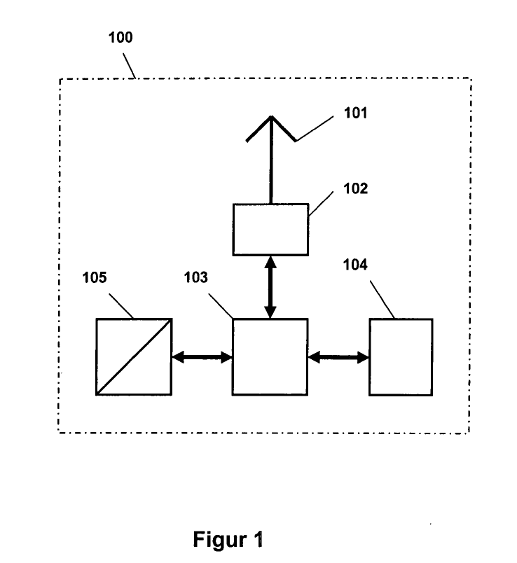

FIG. 1 shows a block diagram of an exemplary transponder 100 according to the features of the disclosure. The transponder 100 has an antenna 101, which is connected to a communications circuit 102. In addition, a digital circuit 103 is provided, which is connected to a memory 104. According to the disclosure, the transponder 100 has a transducer 105 for converting a physical quantity into an electrical quantity, said transducer being connected to the digital circuit 103. The digital circuit 103 can be implemented by a microcontroller.

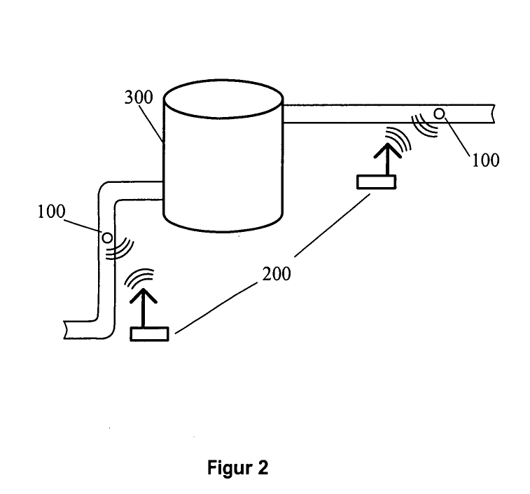

The transponder 100 as shown in FIG. 2 is in non-contact communication with a read device 200 in close proximity. A high-frequency electromagnetic field generated by the read device 200 is modified here by the transponder 100 by load modulation as a function of the data to be transmitted. The field changes are detected in the read device 200 and the data encoded therein is reconstructed.

In a first embodiment, the transponder 100 is supplied with power from the high-frequency electromagnetic field, and is referred to below as a passive transponder.

In an alternative embodiment, the transponder 100 is equipped with a local energy store, which supplies the transponder 100 with power. The transponder having this embodiment is referred to below as an active transponder.

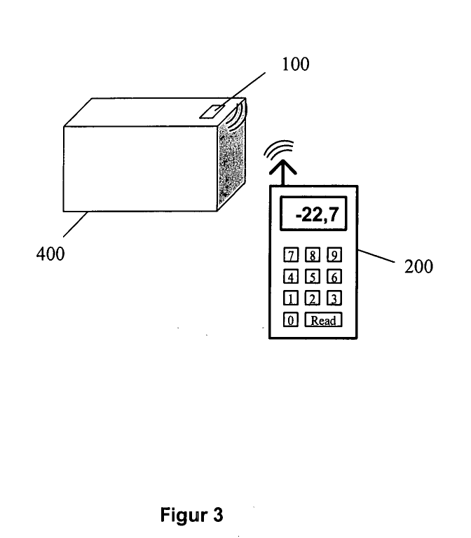

Static information for identifying the transponder 100 is stored in the memory 104. For an active transponder 100, it can be provided to measure the physical quantity continuously or periodically and record the measurements in the memory 104. On coming within range of a read device 200, the series of measurements is then transmitted to the read device 200. For this purpose, a product 400 is equipped with an active transponder 100, as shown in FIG. 3. During storage and transport of the product 400, a physical quantity of the product 400 such as the temperature, is recorded periodically. When definable events occur, such as shipment or handover to the customers, the read device 200, which preferably comprises means for data processing, is used to read out the recorded series of temperature measurements.

Advantageously, by measuring the physical quantity during the entire production process, transport and/or storage, it is possible to achieve simple and continuous monitoring of certain conditions over time. By this means it is possible to detect the occurrence of prohibited conditions, such as exceeding the maximum temperature during manufacture, a break in the cold chain, compliance with specific minimum cooking times and the like. This provides assistance in quality control and quality assurance using batch identification.

In addition, the communications device according to the disclosure enables simple measurements in hygienically critical areas, such as deep frozen foodstuff. For this purpose, it can be provided to place the transponder 100 in the packaging of the product 400. Opening the packaging or touching the packaged product 400 can thereby be avoided in an inspection.

A passive transponder 100 can be provided to be carried directly by a product flowing through a production facility 300, as shown in FIG. 2, and to be moved through the production facility 300. A plurality of read devices 200 are arranged along the path of the flowing product, which temporarily activate a passing transponder 100 at allotted points in the production facility 300, and read out the measured value.

If the transponder 100 remains in the product after leaving the production facility 300, monitoring can be continued during storage or transport to the end customer.

Advantageously, the communications device according to the disclosure enables end-to-end measurement at any point in the production process, and in particular in a hazardous area. In addition, the communications device allows extremely versatile use both with stationary and mobile read devices 200.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCES

100 transponder
101 antenna
102 communications circuit
103 digital circuit
104 memory
105 transducer
200 read device
300 production facility
400 product

What is claimed is:

1. A communications device for transmitting data on a product to a data processing device, the product being assigned a transponder, which can be brought into communication as required with a read device assigned to the data processing device, wherein
the transponder is equipped with a transducer for converting a physical quantity of the product into an electrical quantity.

2. The communications device as claimed in claim 1, wherein
the transponder is supplied externally with power from an electromagnetic field generated by the read device.

3. The communications device as claimed in claim 1, wherein
the transponder is supplied with power from a local energy store.

4. The communications device as claimed in claim 1, wherein
the transponder can be carried in a product flow through the vessels of a production facility.

5. The communications device as claimed in claim 2, wherein
the transponder can be carried in a product flow through the vessels of a production facility.

6. The communications device as claimed in claim 3, wherein
the transponder can be carried in a product flow through the vessels of a production facility.
